(19) United States
(12) Patent Application Publication
(10) Pub. No.: US 2003/0235445 A1
(43) Pub. Date: Dec. 25, 2003

(54) Fixing apparatus

(75) Inventor: Hirofumi Matsunobu, Sunto-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/175,203

(22) Filed: Jun. 19, 2002

(51) Int. Cl. G03G 15/20

(52) U.S. Cl. 399/326; 399/327

(57) ABSTRACT

This fixing apparatus includes a heating member, a pressure member which sandwiches and feeds a recording sheet in cooperation with the heating member, a first cleaning unit and a second cleaning unit. The first cleaning unit moves the first cleaning member while pressing the first cleaning member against a surface of the heating member. The second cleaning unit moves a second cleaning member, which has a releasing agent, while pressing the second cleaning member against a surface of the heating member.

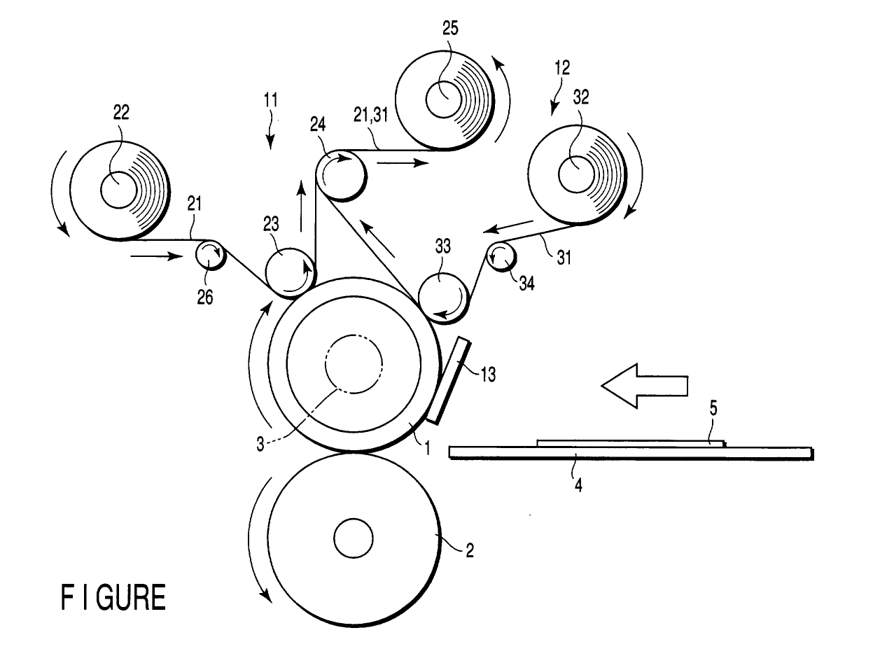

### BACKGROUND OF THE INVENTION

The present invention relates to a fixing apparatus provided in an image forming apparatus.

In an image forming apparatus using electro-photography, a fixing apparatus, which fixes toner images formed on a recording sheet, is provided. An apparatus in which the heating roller method is adopted is used as this fixing apparatus. A fixing apparatus of this method comprises a heating roller and a pressure roller. By rotating these two rollers, a recording sheet is carried between the two rollers and toner images are fixed onto the recording sheet by being heated and pressed.

In a fixing apparatus of this method, part of a toner, which forms toner images, may sometimes come off from a recording sheet during fixing and adhere to the surface of the heating roller. As the toner that has adhered to the surface of the heating roller re-adheres to non-image area of the recording sheet, it debases the quality of toner images.

In order to solve this problem, this fixing apparatus performs the cleaning for the surface of the heating roller. That removes the toner, which has adhered to the surface of the heating roller, by wiping off the surface of the heating roller. In addition, the toner on the recording sheet is prevented from adhering to the surface of the heating roller by applying releasing agent to the surface of the roller.

In a conventional fixing apparatus, a belt-shaped sheet comprising a web is used as a cleaning member in order to clean the surface of the heating roller. The cleaning member has releasing agent, and this cleaning member moves as it is pressed against the surface of the heating roller. The cleaning member remove the toner from the surface of the heating roller, by coming into contact with the surface of the heating roller and being adhered the toner that has adhered to the surface of the heating roller. The cleaning member comes into contact with the surface of the heating roller and applies the releasing agent held by the cleaning member itself to the surface of the heating roller.

A conventional fixing apparatus as described above has the following problem. When the force for pressing the cleaning member is increased in order to raise the rate for adhering the toner to the cleaning member, the cleaning member sticks to the heating roller causing the releasing agent has congealed on the surface of the heating roller during the heating roller stops. When the heating roller starts to rotate, the movement of the cleaning member and the rotation of the heating roller are impeded. Since the cleaning member performs both the wiping the toner off and the applying the releasing agent onto the surface of the heating roller with which the cleaning member contacts, the toner hinders the releasing agent. Therefore the releasing agent cannot be satisfactorily applied to the surface of the heating roller.

### BRIEF SUMMARY OF THE INVENTION

The purpose of the present invention provides a fixing apparatus in which the conventional problem is solved.

A fixing apparatus according to an aspect of the present invention comprises: a heating member, which is moved in a circumferential direction; a pressure member, which sandwiches and carries the recording sheet in cooperation with the heating member; a first cleaning unit, which comprises a first cleaning member that moves while being in contact with the surface of the heating member by being pressed; and a second cleaning unit, which comprises a second cleaning member that is provided side by side with reference to the first cleaning unit in the rotating direction of the heating member. The second cleaning member has a releasing agent thereon and moves while in contact with the surface of the heating member by being pressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

The single FIGURE is a schematic view showing a fixing apparatus related to an embodiment of the invention.

### DETAILED DESCRIPTION OF THE INVENTION

An embodiment of the present invention will be described below by referring to the drawing.

The FIGURE is a schematic view showing a fixing apparatus related to an embodiment of the invention. In an image forming apparatus, the fixing apparatus fixes toner images, which have been transferred from a photosensitive member to a recording sheet, on the recording sheet. The fixing apparatus is a type that fixes toner images on a recording sheet by heating and pressing.

The fixing apparatus comprises a heating roller 1, which is an example of a heating member, and a pressure roller 2, which is an example of a pressure member. The heating roller 1 is, for example, a hollow cylinder, which is horizontally disposed and rotatably supported. The pressure roller 2 is, for example, a solid cylinder, which is disposed beneath the heating roller 1 in parallel with the heating roller 1 and rotatably supported.

The heating roller 1 is heated by a heater 3 to a temperature necessary for fixing. As the pressure roller 2 is given a forward force by a member which is not shown, the pressure roller 2 is brought into contact with the heating roller 1 by being pressing. The heating roller 1 is rotated by a drive mechanism on the center axis of the heating roller 1 as the center of rotation in the direction of an arrow shown in the FIGURE. In other words, the heating roller 1 is an example of a heating member moved in a circumferential direction. The pressure roller 2 is rotated by the rotation of the heating roller 1 on the center axis of the pressure roller 2 as the center of rotation in the direction of an arrow shown in the FIGURE. In other words, the pressure roller 2 is moved in a circumferential direction.

A recording sheet 4 is conveyed in the direction of an arrow shown in the FIGURE, passing through a contact portion between the surface of the heating roller 1 and the surface of the pressure roller 2. A toner image 5 is transferred onto the top surface of the recording sheet 4. The toner image 5 on the recording sheet 4 is heated by the heating roller 1, is pressed by the heating roller 1 and pressure roller 2, and is fixed on the recording sheet 4.

When the toner image 5 on the recording sheet 4 is fixed, part of the toner forming the toner image 5 detaches from the recording sheet 4 and adheres to the surface of the heating roller 1. The toner, which has adhered to the surface of the heating roller 1, deteriorates the quality by adhering to a non-image area of the recording sheet. The fixing apparatus according to the present invention comprises a first cleaning unit 11 and a second cleaning unit 12, which clean the surface of the heating roller 1, in order to cope with the phenomenon of the adherence of toner to the surface of the heating roller 1.

The first cleaning unit 11 and second cleaning unit 12 are provided side by side in the rotating direction (moving direction) of the heating roller 1 surrounding the heating roller 1. The first cleaning unit 11 is provided in a position on the upstream side of the rotating direction (moving direction) of the heating roller 1 with reference to the second cleaning unit 12. The second cleaning unit 12 is provided on the downstream side of the rotating direction (moving direction) of the heating roller 1 with reference to the first cleaning unit 11. A releasing agent controlling member 13 is provided in a position on the downstream side of the rotating direction (moving direction) of the heating roller 1 with reference to the second cleaning unit 12.

The first cleaning unit 11 has a first cleaning member 21. This first cleaning member 21 is a belt-shape sheet comprising a web. The first cleaning member 21 has a length of such a size that permits continuous use and a width that corresponds to the length of the heating roller 1. The first cleaning member 21 has no releasing agent.

The first cleaning unit 11 has a feed roller 22, a pressure roller 23, a tension roller 24, a rewind roller 25 and an auxiliary tension roller 26.

The feed roller 22 is an example of a member which feeds the first cleaning member 21. The feed roller 22 is provided parallel to the heating roller 1. The feed roller 22 holds the first cleaning member 21 by winding the first cleaning member 21 in roll shape. The pressure roller 23 is an example of a member which brings the first cleaning member 21 into contact with the surface of the heating member 1 by pressing the first cleaning member 21 against the heating member 1. The pressure roller 23 is provided parallel to the heating roller 1. The pressure roller 23 can move in directions in which the pressure roller 23 approaches or comes away from the heating roller 1. The pressure roller 23 is applied a force toward the heating roller 1 by a member which is not shown. The first cleaning member 21 is pressed with a force strong enough to wipe off the toner on the surface of the heating roller 21.

The tension roller 24 supports the first cleaning member 21 which has passed by the pressure roller 23. The tension roller 24 is provided parallel to the heating roller 1. The rewind roller 25 is an example of a member that rolls up the first cleaning member 21. The rewind roller 25 is provided parallel to the heating roller 1. The auxiliary tension roller 26 supports the first cleaning member 21 between the feed roller 22 and the pressure roller 23.

The rewind roller 25 is rotated by a mechanism not shown in the wind-up direction on the axis of the rewind roller 25 with the center axis thereof serving as the center of rotation in order to move the first cleaning member 21 in the direction of an arrow shown in the FIGURE. The feed roller 22, pressure roller 23, tension roller 24 and auxiliary tension roller 26 are rotated on the center axes thereof serving as the centers of rotation, for example, with the movement of the first cleaning member 21.

The operation of the first cleaning unit 11 will be described below. The first cleaning member 21 is fed from the feed roller 22, moves in the direction of an arrow shown in the FIGURE while being supported by the auxiliary tension roller 26, and is brought into contact with the surface (external peripheral surface) of the heating roller 1 by being pressed by the pressure roller 23. As shown in-the FIGURE, the first cleaning member 21 moves in the same direction as the rotating direction (moving direction) of the heating roller 1 and is brought into contact therewith. The first cleaning member 21 leaves from the surface of the heating roller 1 and moves in the direction of an arrow shown in the FIGURE while being supported by the tension roller 24. The first cleaning member 21 is finally rolled up by the rewind roller 25 that rotates in the direction of an arrow shown in the FIGURE.

As the first cleaning member 21 is pressed against the surface of the heating roller 1 and moves while in contact with the surface of the heating roller 1, the first cleaning member 21 wipes off the toner adhering to the surface of the heating roller 1 and removes the toner from the surface of the heating roller 1. The first cleaning member 21 can easily wipe off the toner adhering to the surface of the heating roller 1 because the first cleaning member 21 moves in the same direction as the rotating direction (moving direction) of the heating roller 1 and comes into contact with the surface of the heating roller 1. Since the first cleaning member 21 is pressed with a force strong enough to wipe off the toner adhering to the surface of the heating roller 1, the first cleaning member 21 can sufficiently and positively remove the toner adhering to the surface of the heating roller 1.

The moving speed of the first cleaning member 21 is lower than the peripheral speed of the heating roller 1, i.e., the moving speed in a peripheral direction thereof. Owing to this difference in speed, the effect of wiping off of the toner of the heating roller 1 by the first cleaning member 21 is improved. Moreover, the speed at which the first cleaning member 21 wipes off the toner of the heating roller 1 is reduced and hence this is economical. Furthermore, the load on a motor included in the drive mechanism, which rotates the shaft of the rewind roller 25, can be reduced because it is possible to reduce the speed at which the first cleaning member 21 is rolled up by the shaft of the rewind roller 25.

The first cleaning member 21 is given tension while being supported by the auxiliary tension roller 26 in a position on the upstream side of the moving direction with reference to the position of contact between the heating roller 1 and the pressure roller 23 and supported by the tension roller 24 in a position on the downstream side. Therefore, the pressure roller 23 can positively press the first cleaning member 21 to the heating roller 1 keeping in a sufficiently tight condition.

The second cleaning member 12 comprises a second cleaning member 31. This second cleaning member 31 is a belt-shape sheet comprising a web. The second cleaning member 31 has a length of such a size that permits continuous use and a width that corresponds to the length of the heating roller 1. The second cleaning member 31 has a releasing agent to be applied to the heating roller 1. This releasing agent is, for example, a liquid, with which the second cleaning member 31 is impregnated or which is applied to the second cleaning member 31. For example, silicon oil is used as the releasing agent.

The second cleaning unit 12 has a feed roller 32, a pressure roller 33, the tension roller 24, the rewind roller 25 and an auxiliary tension roller 34.

The feed roller 32 is an example of a member which feeds the second cleaning member 31, and this feed roller 32 is provided parallel to the heating roller 1. The feed roller 32 holds the second cleaning member 21 by winding the second cleaning member 21 in roll shape. The pressure roller 33 is an example of a member that brings the second cleaning member 21 into contact with the surface of the heating member 1 by pressing. The pressure roller 33 is provided parallel to the heating roller 1. The pressure roller 33 can move in directions in which the pressure roller 33 approaches or leaves from the heating roller 1. The pressure roller 33 is applied a force toward the heating roller 1 by a member which is not shown. The position in which the pressure roller 33 comes into contact with the heating roller 1 is a position on the downstream side of the rotating direction (moving direction) of the heating roller 1 with reference to the position in which the pressure roller 23 comes into contact with the heating roller 1. The force with which the pressure roller 33 presses the second cleaning member 31 against the heating roller 1 is a level at which the releasing agent of the second cleaning member 31 can be applied to the heating roller 1. The force with which the second cleaning member 31 is pressed is smaller than the force with which the first cleaning member 21 is pressed.

The tension roller 24 supports the second cleaning member 31 which has passed by the pressure roller 33. The tension roller used in the first cleaning unit 11 is shared by the second cleaning unit. The rewind roller 25 is an example of a member which rolls up the second cleaning member 31, and the rewind roller used in the first cleaning unit 11 is shared for the second cleaning unit. The auxiliary tension roller 34 supports the second cleaning member 31 between the feed roller 32 and the pressure roller 33.

As described above, the rewind roller 25 is rotated by a mechanism, which is not shown, in the rewind direction on the axis of the rewind roller 25 with the center axis thereof serving as the center of rotation. The feed roller 32, pressure roller 33, tension roller 24 and auxiliary tension roller 34 are rotated on the center axes thereof serving as the centers of rotation with the movement, for example, the movement of the second cleaning member 31.

The operation of the second cleaning unit 12 will be described below. The second cleaning member 31 is fed from the feed roller 32, moves in the direction of an arrow shown in the FIGURE while being supported by the auxiliary tension roller 34, and is pressed against the surface (external peripheral surface) of the heating roller 1 by the pressure roller 33. The second cleaning member 31 moves in the direction reverse to the rotating direction (moving direction) of the heating roller 1 and comes into contact with the heating roller 1. The second cleaning member 31 leaves from the surface of the heating roller 1 and moves in the direction of an arrow shown in the FIGURE while being supported by the tension roller 24. The second cleaning member 31 is finally rolled up by the rewind roller 25 which rotates in the direction of an arrow shown in the FIGURE.

In other words, when the second cleaning member 31 has moved to the tension roller 24, the second cleaning member 31 moves while being supported by the tension roller 24, layering with the first cleaning member 21 which has similarly moved to the tension roller 24. Subsequently, the second cleaning member 31 is rolled up by the rewind roller 25 while being layered with the first cleaning member 21.

As the second cleaning member 31 moves while being pressed against the surface of the heating roller 1, the second cleaning member 31 applies the releasing agent held by the second cleaning member 31 itself to the surface of the heating roller 1. When the heating roller 1 rotates in the direction of an arrow shown in the FIGURE, the releasing agent is continuously applied to the surface. In this place, the toner adhering to the surface of the heating roller 1 has already been removed. Therefore, it is necessary only that the second cleaning member 31 is pressed to the heating roller 1 with a force large enough to apply the releasing agent to the surface of the heating roller 1. Thus it is unnecessary for the second cleaning member 31 to be pressed to the heating roller 1 with a large force necessary for wiping off the toner adhering to the heating roller 1.

The releasing agent controlling member 13 controls the thickness of a releasing agent by coming into contact with the surface of the heating roller 1. The releasing agent prevents the toner of the recording sheet 4 from adhering to the surface of the heating roller 1 at the contact portion between the heating roller 1 and the pressure roller 2.

The first cleaning member 21 may sometimes cannot remove all toner adhering to the surface of the heating roller 1, and may remain a small amount of toner remains. The small amount of remaining toner reaches the second cleaning member 31 due to the rotation of the heating roller 1. Since the second cleaning member 31 moves during being pressed against the surface of the heating roller 1, the second cleaning member 31 can remove all toner by wiping off the remaining toner. In this case, the second cleaning member 31 can wipe off the toner simply by being pressed with a force necessary for applying the releasing agent to the heating roller 1.

The moving speed of the second cleaning member 31 is lower than the peripheral speed of the heating roller (the moving speed in a peripheral direction) that rotates. Owing to this difference in speed, the second cleaning member 31 can satisfactorily apply the releasing agent to the heating roller 1 and satisfactorily wipe off the toner remaining on the heating roller 1.

The second cleaning member 31 is given tension by being supported by the auxiliary tension roller 34 in a position on the upstream side and supported by the tension roller 24 in a position on the downstream side in the moving direction of the second cleaning member 31 with reference to the portion of contact with the pressure roller 33. Therefore, the pressure roller 34 can positively press the second cleaning member 31 to the heating roller 1 keeping in a sufficiently tight condition.

As the tension roller 24 is shared by the first cleaning unit 11 and the second cleaning unit 12, the number of members can be reduced. The tension roller 24 has also the function of guiding the first cleaning member 21 and second cleaning member 31 to the rewind roller 25. As the rewind roller 25 is shared by the first cleaning unit 11 and the second cleaning unit 12, the number of members can be reduced.

The fixing apparatus first removes the toner adhering to the surface of the heating roller 1 by the first cleaning member 21 of the first cleaning unit 11 after the heating roller 1 rotates and the surface of the heating roller 1 passes by the portion of contact with the pressure roller 2. The first cleaning member 21 can positively remove the toner by being pressed against the heating roller 1 with a force necessary for removing the toner without being stuck by the releasing agent.

Next, the second cleaning member 31 of the second cleaning unit 12 applies the releasing agent to the surface of the heating roller 1. Therefore, the second cleaning member 31 can apply the releasing agent by being pressed against the heating roller 1 with a force necessary for applying the releasing agent without being interfered with by the toner.

The present invention is not limited to the above-described embodiment. For example, the heating member is not limited to a roller and can also be applied an endless belt that moves in a circumferential direction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus which fixes toner images formed on a recording sheet, comprising:
a heating member, which is moved in a circumferential direction;
a pressure member, which sandwiches and carries said recording sheet in cooperation with said heating member;
a first cleaning unit, which comprises a first cleaning member that moves while in contact with the surface of the heating member by being pressed; and
a second cleaning unit, which comprises a second cleaning member that is provided side by side with reference to said first cleaning unit in the moving direction of said heating member, has a releasing agent thereon, and moves while in contact with the surface of the heating member by being pressed.

2. The fixing apparatus according to claim 1, wherein said first cleaning member and said second cleaning member each comprise a web.

3. The fixing apparatus according to claim 1, wherein said second cleaning unit is provided in a position on the downstream side of the moving direction of said heating member with reference to said first cleaning unit.

4. The fixing apparatus according to claim 1, wherein said first cleaning member is pressed against said heating member with a force which is larger than a force with which said second cleaning member is pressed against said heating member.

5. The fixing apparatus according to claim 1, wherein said first cleaning member moves in the same direction in which said heating member moves and wherein said second cleaning member moves into reverse direction in which said heating member moves.

6. The fixing apparatus according to claim 1, wherein said first cleaning unit has a member which feeds said first cleaning member, a member which brings said first cleaning member into contact with said heating member by pressing, and a member which rolls up said first cleaning member, and wherein said second cleaning unit has a member which feeds said second cleaning member, a member which brings said second cleaning member into contact with said heating member by pressing, and a member which rolls up said second cleaning member.

7. The fixing apparatus according to claim 1, wherein said first cleaning unit and said second cleaning unit have a member which rolls up, in common, said first cleaning member and said second cleaning member.

8. The fixing apparatus according to claim 1, wherein said first cleaning unit and said second cleaning unit have a member which supports, in common, said first cleaning member and said second cleaning member.

9. The fixing apparatus according to claim 1, wherein said first cleaning member moves slower than the circumferential moving speed of said heating member.

10. The fixing apparatus according to claim 1, wherein said heating member is a roller which is rotated on the axis thereof.
